(19) United States
(12) Patent Application Publication
(10) Pub. No.: US 2025/0158777 A1
(43) Pub. Date: May 15, 2025

(54) INDICATION OF MEDIUM ACCESS CONTROL (MAC) PROTOCOL DATA UNIT (MPDU) ENCODING

(71) Applicant: QUALCOMM Incorporated, San Diego, CA (US)

(72) Inventors: Abhishek Pramod PATIL, San Diego, CA (US); Alfred ASTERJADHI, San Diego, CA (US); Sai Yiu Duncan HO, San Diego, CA (US); George CHERIAN, San Diego, CA (US); Gaurang NAIK, San Diego, CA (US)

(21) Appl. No.: 18/505,926

(22) Filed: Nov. 9, 2023

(51) Int. Cl. H04L 5/00; H04L 1/1607

(52) U.S. Cl. CPC H04L 5/0053; H04L 1/1614; H04L 1/1642

(57) ABSTRACT

This disclosure provides methods, components, devices and systems for indication of medium access control (MAC) protocol data unit (MPDU) encoding. A first wireless device may receive a message indicating a format of an MPDU frame, from a set of multiple MPDU frames, or an interpretation configuration for one or more first fields of the MPDU frame, from a set of multiple interpretation configurations for the one or more first fields, or both. The first wireless device may receive the MPDU frame and decode the MPDU frame in accordance with the format of the MPDU frame or the interpretation configuration for the one or more first fields, or both. In some examples, the message may be carried in one or more second fields of an MPDU delimiter, may be a physical protocol data unit (PPDU), or may be a MAC header.

### TECHNICAL FIELD

This disclosure relates to wireless communication and, more specifically, to indication of medium access control (MAC) protocol data unit (MPDU) encoding.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a first wireless device (for example, an STA or an AP) may transmit a medium access control (MAC) protocol data unit (MPDU) to a second wireless device (for example, an STA or an AP). The MPDU may carry data in one or more fields, and the second wireless device may decode the one or more fields of the MPDU. The MPDU may be carried within a physical layer (PHY) protocol data unit (PPDU). In some implementations, the first wireless device may transmit, via the PPDU, an aggregate MPDU (A-MPDU) that includes multiple MPDU frames.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless device. The method may include receiving a message indicating a format of a medium access control (MAC) protocol data unit (MPDU) frame, from a set of multiple formats of the MPDU frame, or an interpretation configuration for one or more first fields of the MPDU frame, from a set of multiple interpretation configurations for the one or more first fields, or both, receiving the MPDU frame, and decoding the MPDU frame in accordance with the format of the MPDU frame or the interpretation configuration for the one or more first fields, or both.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to receive a message indicating a format of a MPDU frame, from a set of multiple formats of the MPDU frame, or an interpretation configuration for one or more first fields of the MPDU frame, from a set of multiple interpretation configurations for the one or more first fields, or both, receive the MPDU frame, and decode the MPDU frame in accordance with the format of the MPDU frame or the interpretation configuration for the one or more first fields, or both.

Another innovative aspect of the subject matter described in this disclosure can be implemented in a first wireless device for wireless communications. The first wireless device may include means for receiving a message indicating a format of a MPDU frame, from a set of multiple formats of the MPDU frame, or an interpretation configuration for one or more first fields of the MPDU frame, from a set of multiple interpretation configurations for the one or more first fields, or both, means for receiving the MPDU frame, and means for decoding the MPDU frame in accordance with the format of the MPDU frame or the interpretation configuration for the one or more first fields, or both.

Another innovative aspect of the subject matter described in this disclosure can be implemented in a non-transitory computer-readable medium storing code for wireless communications. The code may include instructions executable by one or more processors to receive a message indicating a format of a MPDU frame, from a set of multiple formats of the MPDU frame, or an interpretation configuration for one or more first fields of the MPDU frame, from a set of multiple interpretation configurations for the one or more first fields, or both, receive the MPDU frame, and decode the MPDU frame in accordance with the format of the MPDU frame or the interpretation configuration for the one or more first fields, or both.

In some examples of the method, first wireless devices, and non-transitory computer-readable medium described herein, the message may be carried in one or more second fields of an MPDU delimiter corresponding to the MPDU frame and the one or more second fields indicate the format of the MPDU frame or the interpretation configuration for the one or more first fields, or both.

In some examples of the method, first wireless devices, and non-transitory computer-readable medium described herein, the message may be a physical layer protocol data unit (PPDU) and one or more second fields in a preamble of the PPDU, one or more service fields of the PPDU, or both, indicate the format of the MPDU frame or the interpretation configuration for the one or more first fields, or both.

In some examples of the method, first wireless devices, and non-transitory computer-readable medium described herein, the message may be a MAC header and one or more second fields in the MAC header indicate the format of the MPDU frame or the interpretation configuration for the one or more first fields, or both.

In some examples of the method, first wireless devices, and non-transitory computer-readable medium described herein, the format of the MPDU frame or the interpretation configuration for the one or more first fields, or both, indicate at least one of a protection of a MAC header, that one or more second fields of the MPDU frame may be expanded, or that one or more third fields of the MPDU frame carry timestamp information, or a combination thereof.

Another innovative aspect of the subject matter described in this disclosure can be implemented in a method for wireless communications by a first wireless device. The method may include transmitting a message indicating a format of a MPDU frame, from a set of multiple formats of the MPDU frame, or an interpretation configuration for one or more first fields of the MPDU frame, from a set of multiple interpretation configurations for the one or more first fields, or both and transmitting the MPDU frame in accordance with the format of the MPDU frame or the interpretation configuration for the one or more first fields, or both.

Another innovative aspect of the subject matter described in this disclosure can be implemented in a first wireless device for wireless communications. The first wireless device may include a processing system that includes processor circuitry and memory circuitry that stores code. The processing system may be configured to cause the first wireless device to transmit a message indicating a format of a MPDU frame, from a set of multiple formats of the MPDU frame, or an interpretation configuration for one or more first fields of the MPDU frame, from a set of multiple interpretation configurations for the one or more first fields, or both and transmit the MPDU frame in accordance with the format of the MPDU frame or the interpretation configuration for the one or more first fields, or both.

Another innovative aspect of the subject matter described in this disclosure can be implemented in a first wireless device for wireless communications. The first wireless device may include means for transmitting a message indicating a format of a MPDU frame, from a set of multiple formats of the MPDU frame, or an interpretation configuration for one or more first fields of the MPDU frame, from a set of multiple interpretation configurations for the one or more first fields, or both and means for transmitting the MPDU frame in accordance with the format of the MPDU frame or the interpretation configuration for the one or more first fields, or both.

Another innovative aspect of the subject matter described in this disclosure can be implemented in a non-transitory computer-readable medium storing code for wireless communications. The code may include instructions executable by one or more processors to transmit a message indicating a format of a MPDU frame, from a set of multiple formats of the MPDU frame, or an interpretation configuration for one or more first fields of the MPDU frame, from a set of multiple interpretation configurations for the one or more first fields, or both and transmit the MPDU frame in accordance with the format of the MPDU frame or the interpretation configuration for the one or more first fields, or both.

In some examples of the method, first wireless devices, and non-transitory computer-readable medium described herein, the message may be carried in one or more second fields of an MPDU delimiter corresponding to the MPDU frame and the one or more second fields indicate the format of the MPDU frame or the interpretation configuration for the one or more first fields, or both.

In some examples of the method, first wireless devices, and non-transitory computer-readable medium described herein, the message may be a PPDU and one or more second fields in a preamble of the PPDU, one or more service fields of the PPDU, or both, indicate the format of the MPDU frame or the interpretation configuration for the one or more first fields, or both.

In some examples of the method, first wireless devices, and non-transitory computer-readable medium described herein, the message may be a MAC header and one or more second fields in the MAC header indicate the format of the MPDU frame or the interpretation configuration for the one or more first fields, or both.

In some examples of the method, first wireless devices, and non-transitory computer-readable medium described herein, the format of the MPDU frame or the interpretation configuration for the one or more first fields, or both, indicate at least one of a protection of a MAC header, that one or more second fields of the MPDU frame may be expanded, or that one or more third fields of the MPDU frame carry timestamp information, or a combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of an MPDU frame that supports indication of medium access control (MAC) protocol data unit (MPDU) encoding.

FIG. 6 shows an example of a data frame that supports indication of MPDU encoding.

FIG. 7 shows an example of a data frame that supports indication of MPDU encoding.

FIG. 8 shows an example of a process flow that supports indication of MPDU encoding.

FIG. 9 shows a block diagram of an example wireless communication device that supports indication of MPDU encoding.

FIG. 10 shows a block diagram of an example wireless communication device that supports indication of MPDU encoding.

FIGS. 11-13 show flowcharts illustrating example processes performable by or at a first wireless device that supports indication of MPDU encoding.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In some wireless communications systems, a first wireless device may transmit a medium access control (MAC) protocol data unit (MPDU) frame to a second wireless device. In some implementations, the first wireless device may transmit an aggregate MPDU (A-MPDU) that includes the MPDU frame and one or more other MPDU frames. The MPDU frame may include various enhancements, for example, protection of fields within a MAC header of the MPDU (for example, using one or more security fields in the MPDU frame), an expansion of a sequence number space, or an expansion of a high throughput (HT) control field, among other enhancements. The first wireless device may have a capability to support some enhancements of the MPDU but not others, or the first wireless device may conditionally apply the enhancements to the MPDU frame based on some network conditions. Accordingly, without additional signaling, the second wireless device that receives the MPDU frame may be unaware of which enhancements are enabled for the MPDU frame or that apply to the MPDU frame, which may result in decoding errors or data losses.

In some implementations, a first wireless device may indicate to a second wireless device a format of the MPDU frame or an interpretation configuration for one or more fields of the MPDU. The format of the MPDU frame may indicate the presence or absence of one or more fields in the MPDU frame. The interpretation configuration may indicate how the second wireless device is to interpret the one or more fields of the MPDU. The indicated format of the MPDU frame may be one of a set of multiple formats of the MPDU frame. Likewise, the interpretation configuration for the one or more fields may be one of a set of multiple interpretation configurations for the one or more fields of the MPDU frame. The second wireless device may receive the MPDU frame and decode the MPDU frame using the format, the interpretation configuration for the one or more fields, or both, that the first wireless device indicates.

By indicating the format and/or interpretation of fields that the first wireless device uses to encode and transmit the MPDU frame, the first wireless device may support increased reliability of communications and reduced latency. For example, the indication of the format and interpretation of fields may enable the second wireless device to parse data from the MPDU more efficiently and with greater accuracy. Moreover, because the second wireless device is aware of encoding techniques used for the MPDU, the indication by the first wireless device may reduce errors in decoding, thereby increasing spectral efficiency and reducing a quantity and frequency of retransmissions, resulting in reduced power consumption and reduced processing.

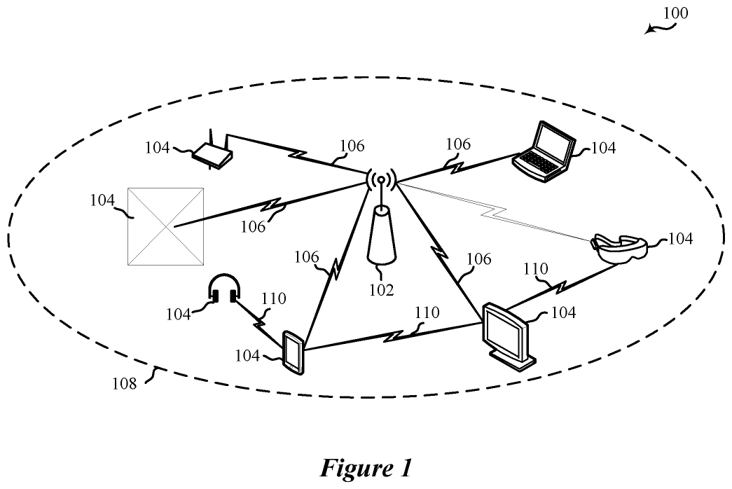

FIG. 1 shows a pictorial diagram of an example wireless communication network 100. According to some aspects, the wireless communication network 100 can be an example of a wireless local area network (WLAN) for example, a Wi-Fi network. For example, the wireless communication network 100 can be a network implementing at least one of the IEEE 802.11 family of wireless communication protocol standards (for example, defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), for example, a 5G or 6G RAN that implements one or more cellular protocols for example, those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, for example, to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (for example, 3GPP, 4G LTE, 5G or 6G) base stations or other cellular network nodes for example, a Node B, an evolved Node B (eNB), a gNB, a transmission reception point (TRP) or another type of device or equipment included in a radio access network (RAN), including Open-RAN (O-RAN) network entities, for example, a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices for example, mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics for example, a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network for example, the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), for example, ULL gaming, or streaming lossless audio and video to one or more personal audio devices (for example, peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications for example, cloud-based applications (for example, VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, for example, the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

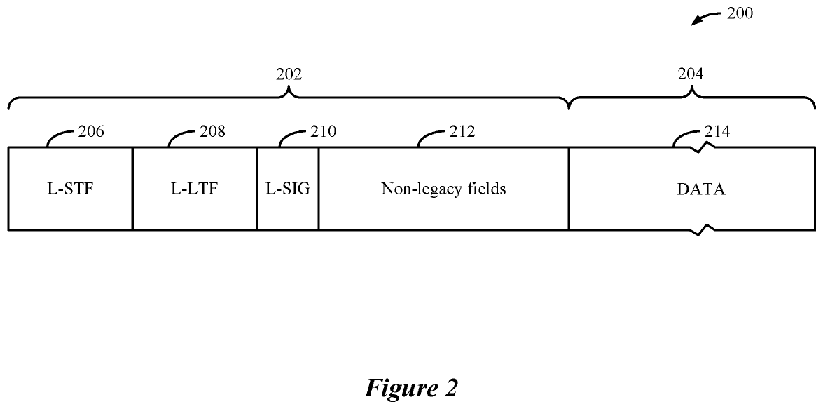

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (for example, an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

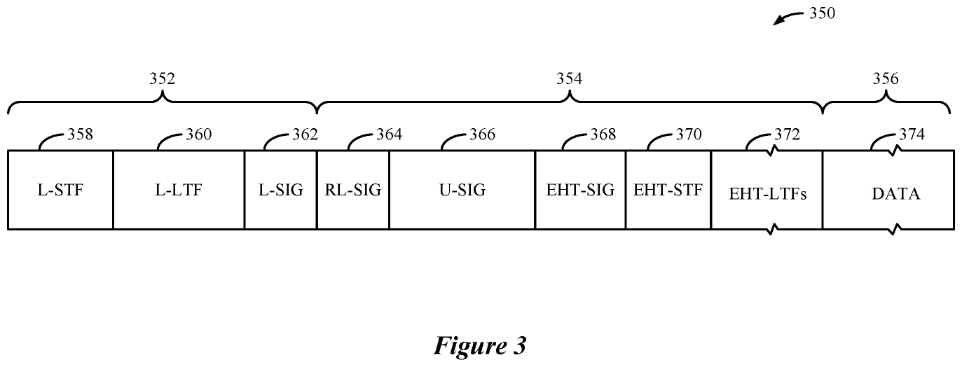

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (for example, the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information for example, user-specific MCS values and user-specific RU allocation information. Such information enables the respective STAs 104 to identify and decode corresponding RUs in the associated data field 374.

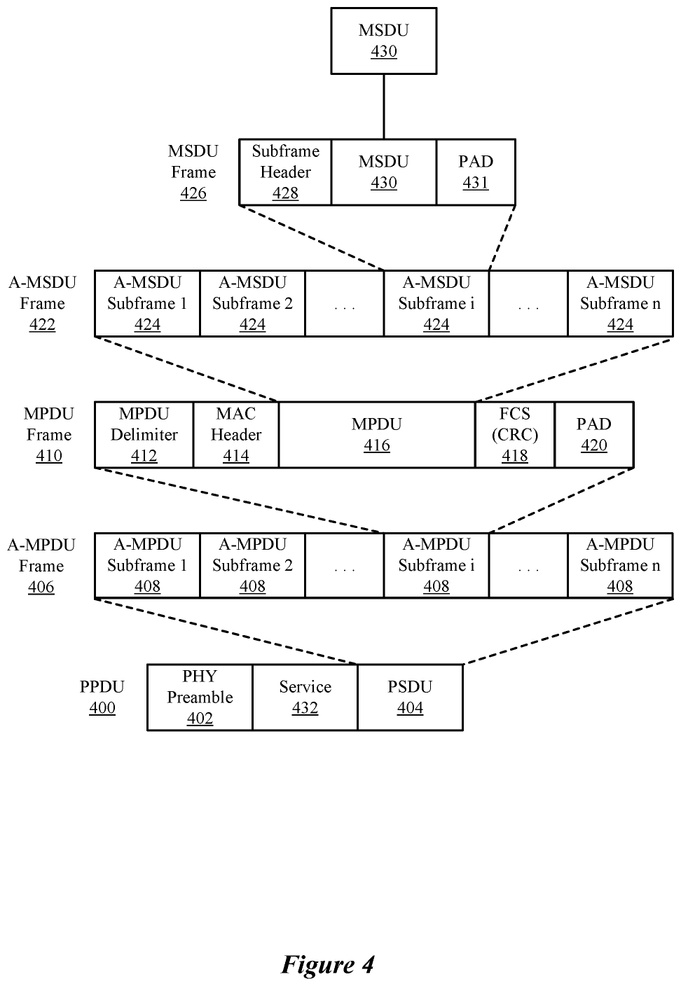

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) frame 406 that includes an aggregation of multiple A-MPDU subframes 408. Each A-MPDU subframe 408 may include an MPDU frame 410 that includes an MPDU delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with (for example, an example of or otherwise referred to as) an MSDU frame 426 and may contain a corresponding MSDU 430 preceded by a subframe header 428 and in some cases followed by padding bits 431.

Referring back to the MPDU frame 410, the MPDU delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (for example, per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, for example, a first RU of an OFDMA transmission, and copied over (for example, duplicated) to another frequency sub-band, for example, a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, for example, a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

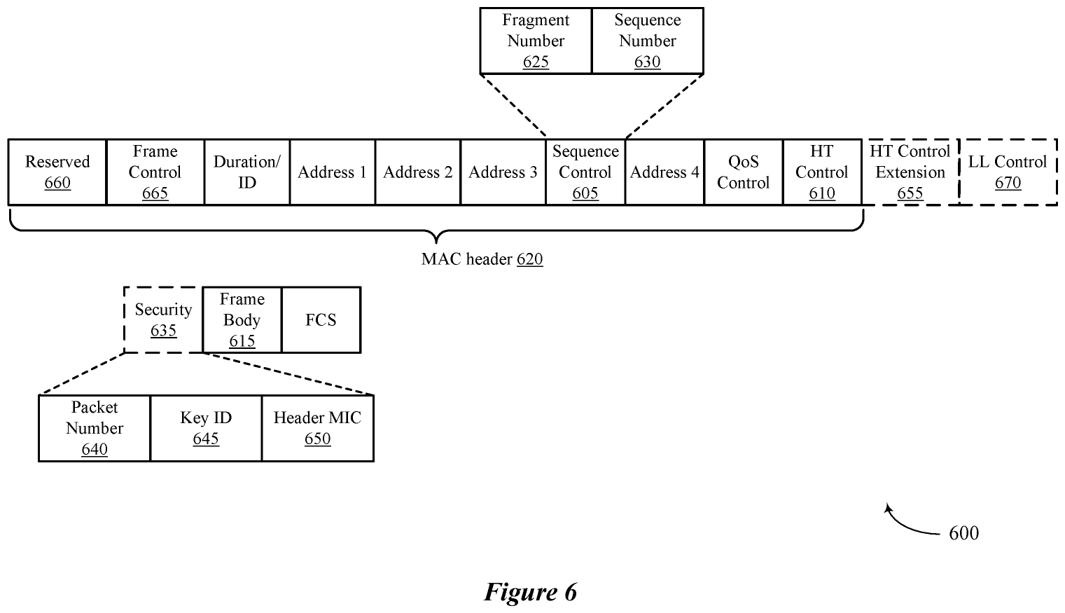

Some wireless devices (for example, ultra-high reliability (UHR) APs 102 and/or UHR STAs 104) may support various enhancements to the MPDU frame 410 which may change either the format of the MPDU frame 410 or the interpretation (such as an interpretation configuration) of fields carried within the MPDU frame 410. For example, the MPDU frame 410 may implement protection of fields within the MAC header 414, and a format of the MPDU frame 410 may change such that the MPDU frame 410 carries additional security fields. In some implementations (for example, for group addressed management frames), the additional security fields may be carried within an element (for example, a new element) or one or more fields after the MAC header 414, as described in greater detail with reference to FIG. 6. A first wireless device (for example, an AP 102, a STA 104) and a second wireless device (for example, an AP 102, a STA 104) may exchange signaling to identify which scheme the first wireless device uses to transmit the MPDU frame 410. For example, the first wireless device may indicate a format or an interpretation configuration for one or more fields of the MPDU frame 410, and the second wireless device may decode the MPDU frame 410 based on the format or the interpretation configuration.

In some implementations, the MPDU frame 410 may have an expanded sequence number space. Expanding the sequence number space may be indicated by a different interpretation of one or more fields. For example, a packet number (PN) field or a fragment number (FN) field may indicate that the sequence number space is expanded (for example, by indicating a size, in octets, of the sequence number space). In some implementations, the MPDU frame 410 may have an expanded high throughput control field, which may support a relatively greater flexibility of aggregated control (A-control) fields within the MPDU frame 410. In some implementations, the MPDU frame 410 may include one or more fields carrying timing information (for example, timestamp information) for low-latency packets.

The first wireless device may transmit an MPDU frame 410 to the second wireless device that includes one or more enhancements to the MPDU frame 410 (for example, expansion of one or more fields, protection of the MAC header 414, fields carrying timing information, among other enhancements), but that excludes other enhancements. The enhancements to be included in the MPDU frame 410 may be based on a capability of the first wireless device, the second wireless device, or both. For example, the second wireless device may indicate support for receiving the MPDU frame 410 in one or more formats and/or with one or more interpretation configurations for one or more fields carried in the MPDU frame 410. The first wireless device can provide such an indication to the second wireless device during an association procedure (for example, association signaling, initiation) with the second wireless device.

In some wireless communications systems, where there may be multiple different candidate formats or candidate interpretation configurations for the MPDU frame 410, the first wireless device and the second wireless device may negotiate, or indicate dynamically, which formats or interpretation configurations may be used during communication between the two devices. For example, the first wireless device (for example, a transmitting STA), which may support some enhancements to the MPDU frame 410 (and may not support some other enhancements) may conditionally apply one or more of the enhancements to the MPDU frame 410 based on various conditions (for example, capabilities of one or more wireless devices, radio link quality, among other considerations).

The first wireless device may utilize or implement a signal mechanism to indicate to a recipient how to interpret contents of the MPDU frame 410. That is, the first wireless device may indicate an encoding scheme for the MPDU frame 410, a format of the MPDU frame 410, or an interpretation configuration for one or more fields of the MPDU frame 410, or a combination thereof. In some implementations, one or more enhancements to the MPDU frame 410 may apply based on the intended recipient being a UHR STA. For example, the first wireless device may apply the one or more enhancements to an individually addressed PPDU 400 to a UHR recipient or a group addressed PPDU 400 carried in a UHR PPDU format (for example, a PPDU format decodable by UHR STAs) or in a broadcast RU meant for UHR STAs only. As such, the one or more enhancements to the MPDU frame 410 may support backwards compatibility.

The MPDU frame 410 may correspond to an A-MPDU subframe 408, which may be one of multiple A-MPDU subframes 408 transmitted by the first wireless device via the A-MPDU frame 406. In some implementations, the first wireless device may indicate different formats or different interpretations of fields for MPDU frames 410 of different A-MPDU subframes 408. For example, the first wireless device may indicate a first format and/or a first interpretation configuration for fields of the MPDU frame 410 and may indicate a second format and/or a second interpretation configuration for fields of a second MPDU frame that is included with the MPDU frame 410 in the A-MPDU frame 406. The first wireless device also may indicate a third format and/or a third interpretation configuration for fields of a third MPDU frame that is included with the MPDU frame 410 and the second MPDU frame in the A-MPDU frame 406. In other words, the first wireless device may indicate a respective format and/or a respective interpretation configuration for each A-MPDU subframe 408 of the A-MPDU frame 406.

In some implementations, the first wireless device may indicate a format of the MPDU frame 410 or an interpretation configuration for one or more fields of the MPDU frame 410 via the PHY preamble 402. For example, the PHY preamble 402 of the PPDU 400 may carry one or more fields to indicate the format of the MPDU frame 410 or how to interpret the one or more fields. Additionally, or alternatively, the first wireless device may indicate the format of the MPDU frame 410 or the interpretation configuration for the one or more fields of the MPDU frame 410 via a service field 432 of the PPDU 400. Combinations of values, or a single value, carried within the service field 432 may provide an indication of the MPDU format or an interpretation of fields within the MPDU frame 410.

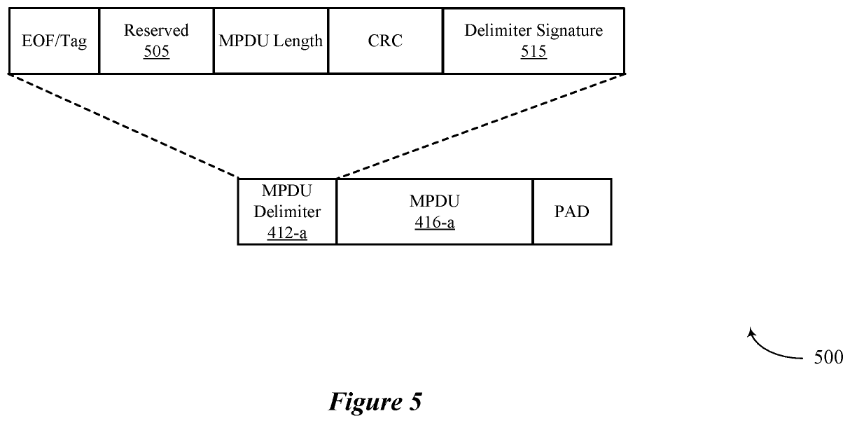

FIG. 5 shows an example of an MPDU frame 500 that supports indication of MPDU encoding. The MPDU frame 500 may be an example of an MPDU frame 410 and may be included in an A-MPDU subframe 408, as described with reference to FIG. 4. The MPDU frame 500 may include an MPDU delimiter 412-a and an MPDU 416-a, which may be an example of an MPDU delimiter 412 and an MPDU 416, respectively, as described with reference to FIG. 4.

In some implementations, a first wireless device may indicate enhancements to the MPDU frame 500 (for example, a format, an interpretation configuration of one or more fields), as described in greater detail with reference to FIG. 4, via the MPDU delimiter 412-a. For example, a reserved field 505 in the MPDU delimiter 412-a may signal that MAC header fields are protected and that the MPDU frame 500 includes additional security fields, that a sequence number space is expanded (for example, via a FN or PN field), that an HT control size exceeds a threshold size (for example, is greater than 4 octets), that the MPDU frame 500 includes timestamp information (for example, for low latency packets), or other formats of the MPDU frame 500, interpretation configurations for one or more fields of the MPDU frame, enhancements to the MPDU frame 500, or a combination thereof.

Additionally, or alternatively, the first wireless device may indicate that one or more formats or interpretation configurations apply to the MPDU frame 500 via a delimiter signature field 515. The delimiter signature field 515 may include a pattern (for example, 0x4E, an American Standard Code for Information Interchange (ASCII) value of the character “N”) that may be used by the second wireless device to detect the MPDU delimiter 412-a when scanning for the MPDU delimiter 412-a.

In some implementations, the delimiter signature field 515 of the MPDU delimiter 412-a may carry a value (different from “N”) that is indicative of the MPDU frame 500 including the one or more formats or interpretation configurations. For example, the delimiter signature field 515 may carry the value “U” (for example, an ACII value of the character “U”) to signal the MPDU frame 500 of a format (enhanced format) or with an interpretation configuration (enhanced interpretation configuration) of one or more fields, or a combination of both. In some other implementations, the delimiter signature field 515 may carry the value “L” (for example, an ACII value of the character “L”). The value “L” may indicate that the MPDU frame 500 carries low-latency data. A format of the MPDU frame 500 or an interpretation configuration for fields of the MPDU frame 500 may enable the MPDU frame 500 to carry information related to low latency operations or low latency communications, may enable indication of such low latency information to the second wireless device, or both.

FIG. 6 shows an example of a data frame 600 that supports indication of MPDU encoding. The data frame 600 may be an example of an MPDU frame 500 or an MPDU frame 410, as described with reference to FIG. 5 and FIG. 4, respectively. The data frame 600 may include a MAC header 620 and a frame body 615, which may be an example of a MAC header 414 and an MPDU 416, respectively, as described with reference to FIG. 4.

One example of a format of the data frame 600, or an interpretation configuration for one or more fields of the data frame 600, that is signaled using techniques described herein may be an expansion of an HT control field 610. A reserved field 660 within the MAC header 620, a combination of values carried in two or more fields of the MAC header 620, or one or more values carried in a single field of the MAC header 620, may indicate expansion of the HT control field 610 to be greater than a threshold size (for example, 4 octets). For example, a first wireless device may indicate, via one or more fields of the MAC header 620, or using any other signaling mechanism described herein (for example, an MPDU delimiter 412, fields of a PPDU 400 a size of the HT control field 610). In some examples, a combination of a first value in a frame control field 665 of the MAC header 620 and a second value in a sequence control field 605 of the MAC header 620 may indicate the expansion of HT control. Any other fields of the MAC header 620 may also include combinations of values indicative of HT control expansion, including fields not shown.

In some implementations, the first wireless device may indicate, via the one or more signaling mechanisms, a format or an interpretation configuration indicating that the data frame 600 includes an HT control extension field 655, which may be an extension of the HT control field 610. In some implementations, the HT control extension field 655 may be referred to as a UHR control field. The HT control extension field 655 may carry information pertaining to UHR features, including formats of the data frame 600, interpretation configurations for the data frame 600, or a combination thereof. For example, the HT control extension field 655 may indicate which one or more UHR features are enabled, a presence of one or more fields (for example, security fields) in the data frame 600, a priority of the data frame 600 or packet, timing information relating to the data frame 600 or packet, or a combination thereof.

The HT control extension field 655 may be an A-control field with a control identifier greater than a threshold value (for example, having a control identifier greater than 10). In some implementations, the HT control extension field 655 may repurpose, or utilize, one or more reserved fields that indicate expanded HT control information or additional HT control information than that which is indicated in the HT control field 610.

In some implementations, the HT control field 610 (having a size greater than 4 octets) or the HT control extension field 655 may include a dedicated field carrying a bitmap to indicate which of the formats or interpretation configurations (for example, UHR features) to apply to an MPDU frame or that are enabled for the MPDU frame. For example, the bitmap may include a first bit to indicate MAC header protection (for example, a presence of security fields in the MPDU frame), a second bit to indicate a sequence number space expansion, a third bit to indicate expansion of the HT control field 610, a fourth bit to indicate that the MPDU frame includes timestamp information, or any combination thereof.

The bitmap to indicate which of the formats or interpretation configurations apply to the MPDU frame or are enabled in the MPDU frame may be signaled using any signaling mechanism described herein. In one example, a delimiter signature field 515 being set to “U”, as described with reference to FIG. 5, may indicate expansion of the HT Control field 610, and the expanded HT control field 610 may carry the bitmap to indicate which UHR features, formats, interpretation configurations, enhancements, or a combination thereof, are applied to the MPDU. Additionally, or alternatively, the first wireless device may signal an indication of the bitmap via one or more fields of the MPDU delimiter 412-a, as described with reference to FIG. 4, via one or more fields of the MAC header 620, via the PHY preamble or the service field 432 of the PPDU 400, as described with reference to FIG. 4, or any combination thereof.

Another example of format of the data frame 600, or an interpretation configuration for fields of the data frame 600, that the first wireless device may indicate via the bitmap, or via other signaling mechanisms described herein, may be an expansion of a sequence number space. A size of a sequence number field 630, which may be included in a sequence control field 605 of the data frame 600, may correspond to the sequence number space. The first wireless device may indicate, via an FN field 625 of the sequence control field 605, that the sequence number field 630 is expanded (for example, by indicating a size, in octets, of the sequence number field 630). Additionally, or alternatively, a PN field may indicate that the sequence number field 630 is expanded.

Another example of format of the data frame 600, or an interpretation configuration for fields of the data frame 600, that the first wireless device may indicate via the bitmap, or via other signaling mechanisms described herein, may be protection of the MAC header 620 in the data frame 600. For example, the first wireless device may indicate that the data frame 600 includes a security field 635. The security field 635 may include a PN field 640, a key identifier field 645, a header message integrity check (MIC) field 650, or a combination thereof. In some implementations, the first wireless device may indicate that one or more of the PN field 640, the key identifier field 645, or the header MIC field 650 are present in the data frame 600, and such fields may be located in other fields of the data frame 600 (for example, in reserved fields of the MAC header 620).

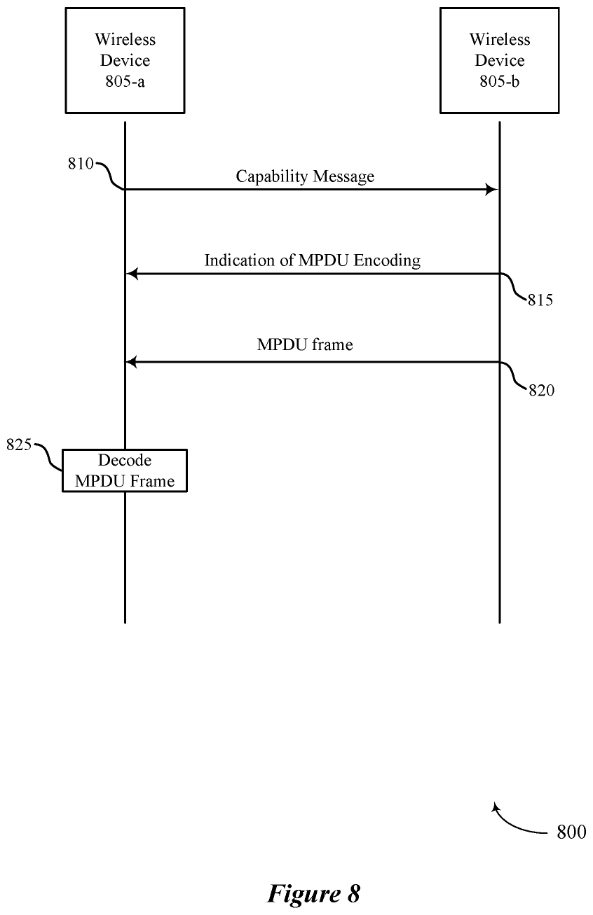

One or more fields in the MAC header 620 may indicate any one or more of the various formats or interpretation configurations for the data frame 600 described herein. For example, a protocol version field of the MAC header 620 may be set to a value (for example, 2), which may indicate that one or more formats or interpretation configurations are present in the data frame 600, or a type/subtype field in the MAC header 620 may indicate that the one or more formats or interpretation configurations are present. In some implementations, a value carried in an A-control field of the HT control field 610 may indicate a format of the data frame 600 or how to interpret one or more fields in the data frame 600. Additionally, or alternatively, the type/subtype field may indicate that the data frame 600 is a subtype of type ‘data’, which may indicate that the data frame 600 includes one or more elements signaling a format or interpretation configuration of fields for the data frame 600, as described in greater detail with reference to FIG. 8.

In some implementations, the first wireless device may indicate, via the one or more signaling mechanisms, a format or an interpretation configuration indicating that the data frame 600 includes a low latency control field 670. For example, the first wireless device may indicate that the data frame 600 is of a low latency format, which may indicate to the second wireless device that the data frame 600 includes the low latency control field 670. The low latency control field 670 may carry latency related information such as a delay bound of the data frame 600 (e.g., MPDU), a cumulative delay experienced since ingress in a MAC-service access point (SAP), among other latency information.

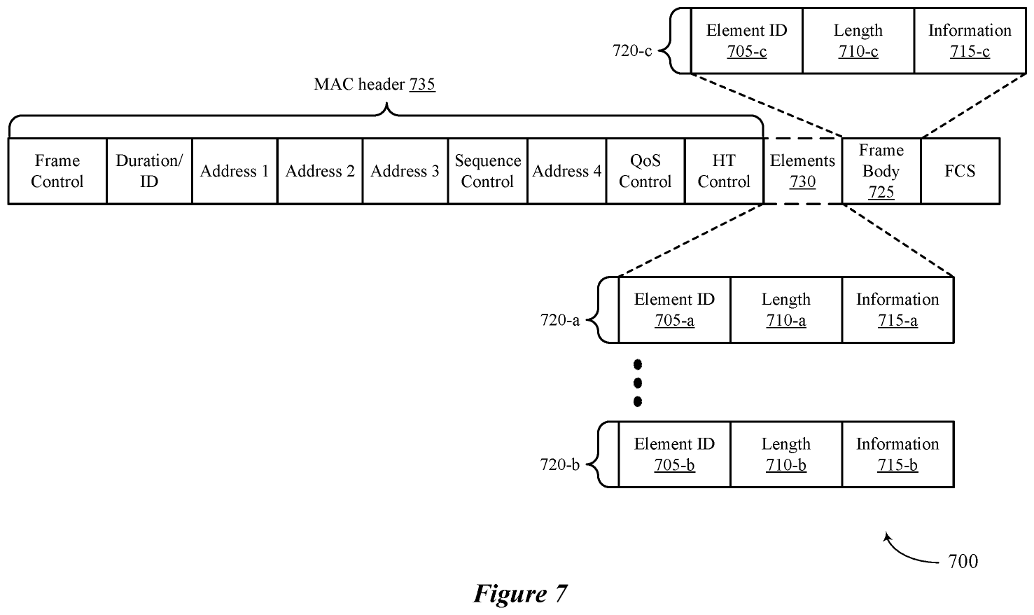

FIG. 7 shows an example of a data frame 700 that supports indication of MPDU encoding. The data frame 700 may be an example of an MPDU frame 500 or an MPDU frame 410, as described with reference to FIG. 5 and FIG. 4, respectively. The data frame 700 may include a MAC header 735 and a frame body 725, which may be an example of a MAC header 414 and an MPDU 416, respectively, as described with reference to FIG. 4.

The data frame 700 may include one or more elements 720 that indicate one or more formats or interpretation configurations of an MPDU frame (for example, one or more enhancements, UHR features), as described herein. In some implementations, the data frame 700 may include a dedicated elements field 730 that includes one or more elements 720 (for example, a list of elements 720). Each of the elements 720 in the elements field 730 may include an element identifier 705 that identifies the element 720, a length field 710 that indicates a length (in octets) of the element 720, and an information field 715 that indicates a format or interpretation configuration of fields for the data frame 700.

In an example, the element 720-a may include an element identifier 705-a, a length field 710-a, and an information field 715-a indicating that the data frame 700 includes one or more security fields associated with protection of the MAC header 735. The element 720-b may include an element identifier 705-b, which may differentiate the element 720-b from the element 720-a. The element 720-b also may include a length field 710-b and an information field 715-b indicating that the data frame 700 includes an expansion of an HT control field, an expansion of a sequence number space, or both.

In some implementations, alternatively to, or in addition to, the data frame including the elements field 730, the frame body 725 of the data frame 700 may include one or more elements 720, for example, an element 720-c. The element 720-c may include an identifier 705-c to differentiate the element 720-c from the element 720-a and the element 720-b. The element 720-c also may include a length field 710-c, and an information field 715-c indicating that the data frame 700 includes timestamp information corresponding to one or more low latency packets. Other elements 720, which may be included in the elements field 730, the frame body 725, or one or more fields of the MAC header 735, may include additional formats or interpretation configurations that are enabled or applied to the data frame 700.

FIG. 8 shows an example of a process flow 800 that supports indication of MPDU encoding. The process flow 800 may implement aspects of the wireless communication network 100, the PDU 200, the PPDU 350, and the PPDU 400. For example, the process flow 800 may include a wireless device 805-a and a wireless device 805-b, which may be examples of an STA 104 or an AP 102, as described with reference to FIG. 1. In the following description of the process flow 800, the operations between the wireless device 805-a and the wireless device 805-b may be transmitted in a different order than the example order shown, or the operations performed by the wireless device 805-a and the wireless device 805-b may be performed in different orders or at different times. Some operations also may be omitted from the process flow 800, and other operations may be added to the process flow 800.

At 810, the wireless device 805-a may transmit a message indicating a first capability of the wireless device 805-a to support one or more formats of an MPDU frame, from a set of multiple formats of the MPDU frame. Additionally, or alternatively, the message may indicate a second capability of the wireless device 805-b to support one or more interpretation configurations for one or more fields of the MPDU frame, from a set of multiple interpretation configurations for the one or more fields.

At 815, the wireless device 805-a may receive a message indicating a format of an MPDU frame, from a set of multiple formats of the MPDU frame, or an interpretation configuration for one or more fields of the MPDU frame, from a set of multiple interpretation configurations for the one or more first fields, or both. For example, the wireless device 805-b may indicate that a format of the MPDU frame includes security fields for protection of a MAC header and/or that at least one of a PN field or a FN field is to be interpreted by the wireless device 805-a as an expansion of a sequence number space. Additionally, or alternatively, the wireless device 805-b may indicate that an HT control field exceeds a threshold size or that the MPDU frame includes timing information for low latency packets.

In some implementations, the message is carried in one or more fields of an MPDU delimiter corresponding to (for example, included in) the MPDU frame. The MPDU delimiter may include one or more reserved fields or a delimiter signature field that indicate the format of the MPDU frame or the interpretation for the one or more fields of the MPDU frame. In some other examples, the message is a PPDU, and one or more fields in a preamble of the PPDU, or one or more security fields of the PPDU, or both, indicate the format of the MPDU frame or the interpretation configuration for the one or more fields of the MPDU frame. In still other examples, the message is a MAC header, and one or more fields in the MAC header (for example, a protocol version subfield, a type/subtype field, an A-control field in an HT control field, one or more reserved fields indicate the format of the MPDU frame or the interpretation configuration for the one or more fields of the MPDU frame.

In some implementations, the message includes a bitmap. A first bit of the bitmap may indicate whether the MPDU frame include one or more security fields (for example, fields that grant protection to a MAC header of the MPDU header). A second bit of the bitmap may indicate whether one or more fields of the MPDU frame (for example, a sequence number space or an HT control field) are expanded.

At 820, the wireless device 805-a may receive the MPDU frame. At 825, the wireless device 805-a may decode the MDPU frame in accordance with the format of the MPDU frame or the interpretation configuration for the one or more fields of the MPDU frame, or both. For example, the wireless device 805-a may determine, based on the format, that the MPDU frame includes one or more security fields or that a MAC header of the MPDU frame is protected. In some implementations, the wireless device may determine that a sequence number space or an HT control field of the MPDU frame is expanded based on decoding the MPDU frame with an awareness or an indication of the interpretation configuration. The wireless device 805-a may receive additional sequence number or HT control information via the one or more expanded fields. Additionally, or alternatively, the wireless device 805-a may receive timestamp information of one or more latency packets based on the decoding and the indication that the MPDU frame has the format or the interpretation configuration.

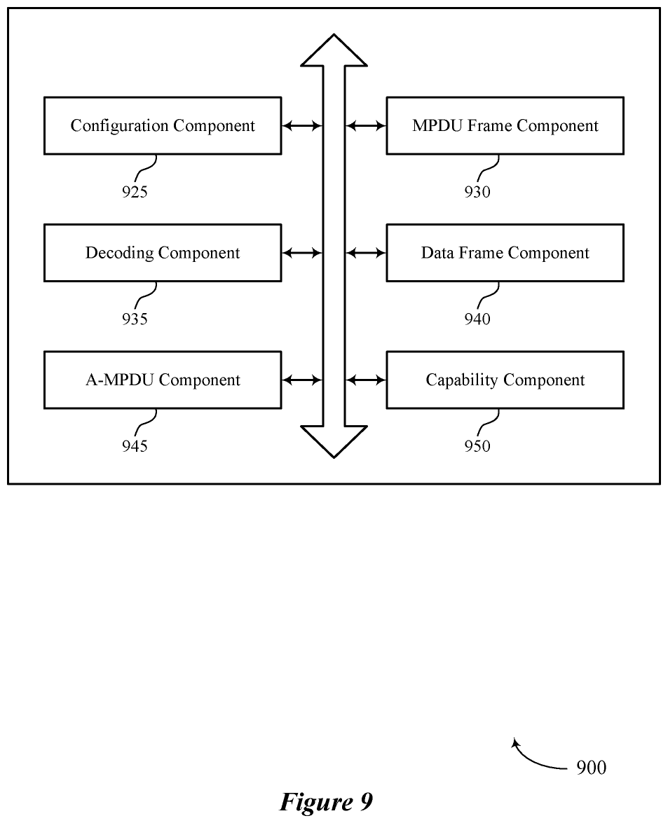

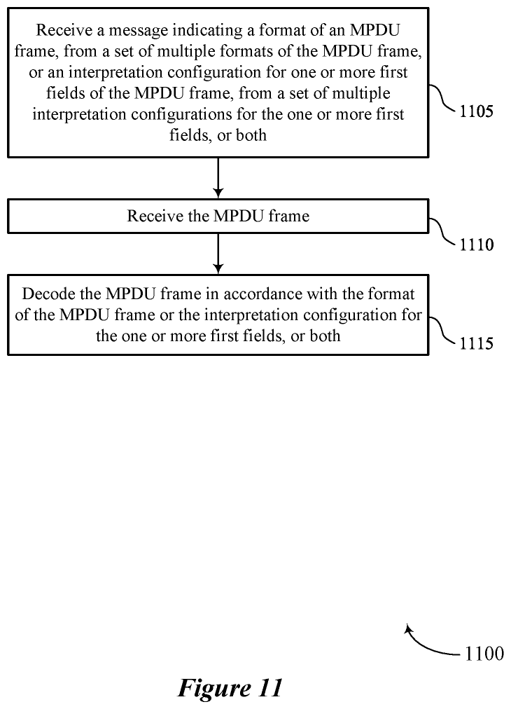

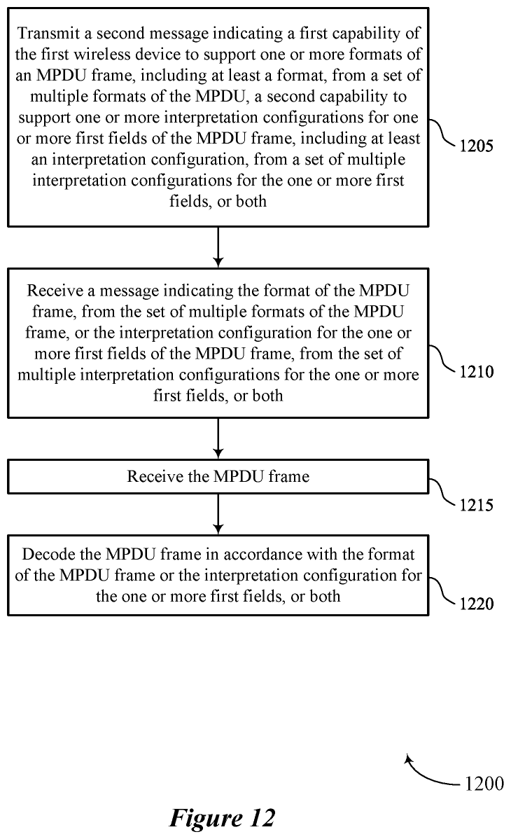

FIG. 9 shows a block diagram of an example wireless communication device 900 that supports indication of MPDU encoding. In some examples, the wireless communication device 900 is configured to perform the processes 1100 and 1200 described with reference to FIGS. 11 and 12, respectively. The wireless communication device 900 may include one or more chips, SoCs, chipsets, packages, components or devices that individually or collectively constitute or include a processing system. The processing system may interface with other components of the wireless communication device 900, and may generally process information (for example, inputs or signals) received from such other components and output information (for example, outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, for example, from the transmission component, and the second interface also may output information, for example, to the reception component.

The processing system of the wireless communication device 900 includes processor (or “processing”) circuitry in the form of one or multiple processors, microprocessors, processing units (for example, central processing units (CPUs), graphics processing units (GPUs) or digital signal processors (DSPs)), processing blocks, application-specific integrated circuits (ASIC), programmable logic devices (PLDs) (for example, field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media for example, random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (for example, a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can configurable or configured for use in a STA, for example, the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (for example, a touchscreen or keypad) and a display, which may be integrated with the UI to form a touchscreen display that is coupled with the processing system. In some examples, the wireless communication device 900 may further include one or more sensors for example, for example, one or more inertial sensors, accelerometers, temperature sensors, pressure sensors, or altitude sensors, that are coupled with the processing system.

The wireless communication device 900 includes a configuration component 925, an MPDU frame component 930, a decoding component 935, a data frame component 940, an A-MPDU component 945, and a capability component 950. Portions of one or more of the configuration component 925, the MPDU frame component 930, the decoding component 935, the data frame component 940, the A-MPDU component 945, and the capability component 950 may be implemented at least in part in hardware or firmware. For example, one or more of the configuration component 925, the MPDU frame component 930, the decoding component 935, the data frame component 940, the A-MPDU component 945, and the capability component 950 may be implemented at least in part by at least a processor or a modem. In some examples, portions of one or more of the configuration component 925, the MPDU frame component 930, the decoding component 935, the data frame component 940, the A-MPDU component 945, and the capability component 950 may be implemented at least in part by a processor and software in the form of processor-executable code stored in memory.

The wireless communication device 900 may support wireless communications in accordance with examples as disclosed herein. The configuration component 925 is configurable or configured to receive a message indicating a format of an MPDU frame, from a set of multiple formats of the MPDU frame, or an interpretation configuration for one or more first fields of the MPDU frame, from a set of multiple interpretation configurations for the one or more first fields, or both. The MPDU frame component 930 is configurable or configured to receive the MPDU frame. The decoding component 935 is configurable or configured to decode the MPDU frame in accordance with the format of the MPDU frame or the interpretation configuration for the one or more first fields, or both.

In some examples, the message be carried in one or more second fields of an MPDU delimiter corresponding to the MPDU frame. In some examples, the one or more second fields indicate the format of the MPDU frame or the interpretation configuration for the one or more first fields, or both.

In some examples, the MPDU delimiter include one or more reserved fields that indicate the format of the MPDU frame or the interpretation configuration for the one or more first fields, or both.

In some examples, the MPDU delimiter include a delimiter signature field. In some examples, a value of the delimiter signature field indicate the format of the MPDU frame or the interpretation configuration for the one or more first fields, or both.

In some examples, the message be a physical layer protocol data unit (PPDU). In some examples, one or more second fields in a preamble of the PPDU, one or more service fields of the PPDU, or both, indicate the format of the MPDU frame or the interpretation configuration for the one or more first fields, or both.

In some examples, the message be a MAC header. In some examples, one or more second fields in the MAC header indicate the format of the MPDU frame or the interpretation configuration for the one or more first fields, or both.

In some examples, the message include a bitmap. In some examples, a first bit of the bitmap indicate whether the MPDU frame includes one or more security fields. In some examples, a second bit of the bitmap indicate whether one or more second fields of the MPDU frame are expanded.

In some examples, the format of the MPDU frame or the interpretation configuration for the one or more first fields, or both, indicate at least one of a protection of a MAC header, that one or more second fields of the MPDU frame are expanded, or that one or more third fields of the MPDU frame carry timestamp information, or a combination thereof.

In some examples, the format of the MPDU frame or the interpretation configuration for the one or more first fields, or both, indicate at least one of a size of a high throughput control field exceeding a threshold, a presence of one or more security fields in the MPDU frame associated with the protection of the MAC header, a sequence number space being expanded based on a FN field, the sequence number space being expanded based on a PN field, or an interpretation for one or more third fields in the MAC header, from a set of multiple interpretations for the one or more third fields in the MAC header, or a combination thereof.

In some examples, to support receiving the message, the data frame component 940 is configurable or configured to receive a data frame associated with the MPDU frame, where the data frame includes one or more elements indicating the format of the MPDU frame or the interpretation configuration for the one or more first fields, or both.

In some examples, the configuration component 925 is configurable or configured to receive a second message indicating a second format of a second MPDU frame or a second interpretation configuration for one or more third fields of the second MPDU frame, or both. In some examples, the A-MPDU component 945 is configurable or configured to receive an aggregate MPDU including the MPDU frame and at least the second MPDU frame.

In some examples, the capability component 950 is configurable or configured to transmit a second message indicating a first capability of the first wireless device to support one or more formats of the MPDU frame, including at least the format, from the set of multiple formats of the MPDU frame, a second capability to support one or more interpretation configurations for the one or more first fields, including at least the interpretation configuration, from the set of multiple interpretation configurations for the one or more first fields, or both.

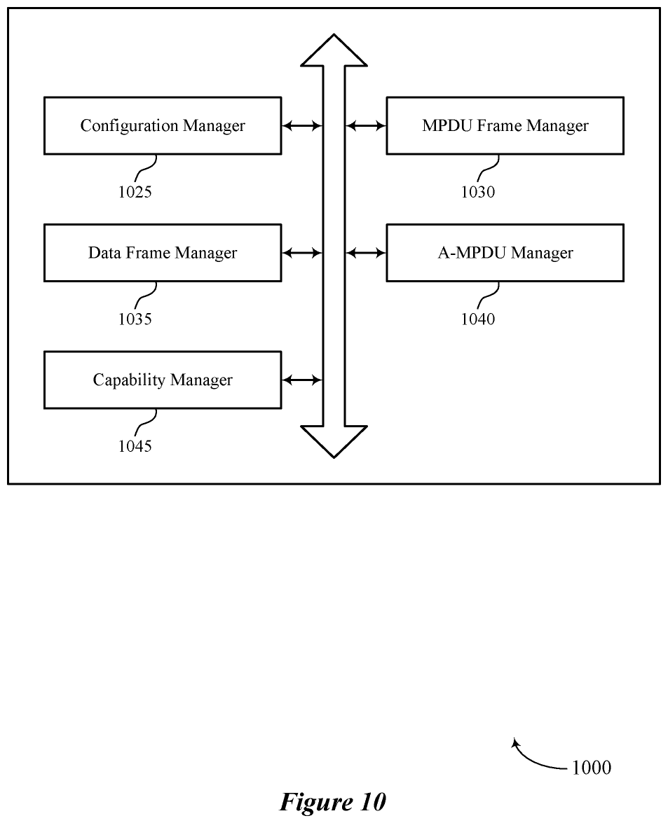

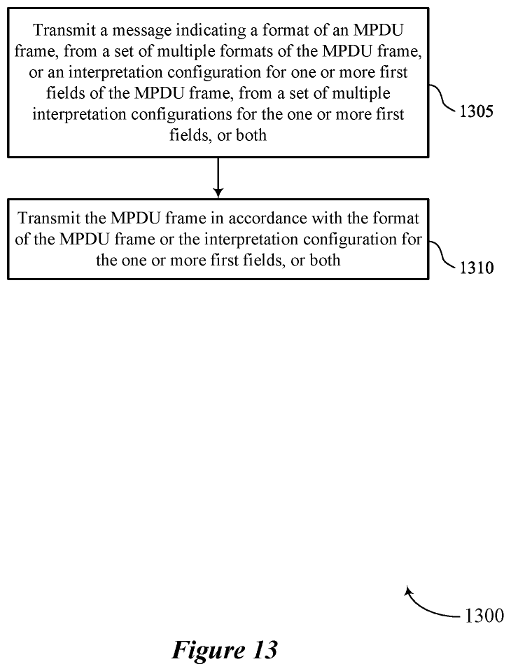

FIG. 10 shows a block diagram of an example wireless communication device 1000 that supports indication of MPDU encoding. In some examples, the wireless communication device 1000 is configured to perform the process 1300 described with reference to FIG. 13. The wireless communication device 1000 may include one or more chips, SoCs, chipsets, packages, components or devices that individually or collectively constitute or include a processing system. The processing system may interface with other components of the wireless communication device 1000, and may generally process information (for example, inputs or signals) received from such other components and output information (for example, outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, for example, from the transmission component, and the second interface also may output information, for example, to the reception component.

The processing system of the wireless communication device 1000 includes processor (or “processing”) circuitry in the form of one or multiple processors, microprocessors, processing units (for example, central processing units (CPUs), graphics processing units (GPUs) or digital signal processors (DSPs)), processing blocks, application-specific integrated circuits (ASIC), programmable logic devices (PLDs) (for example, field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media for example, random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (for example, a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can configurable or configured for use in an AP, for example, the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a configuration manager 1025, an MPDU frame manager 1030, a data frame manager 1035, an A-MPDU manager 1040, and a capability manager 1045. Portions of one or more of the configuration manager 1025, the MPDU frame manager 1030, the data frame manager 1035, the A-MPDU manager 1040, and the capability manager 1045 may be implemented at least in part in hardware or firmware. For example, one or more of the configuration manager 1025, the MPDU frame manager 1030, the data frame manager 1035, the A-MPDU manager 1040, and the capability manager 1045 may be implemented at least in part by at least a processor or a modem. In some examples, portions of one or more of the configuration manager 1025, the MPDU frame manager 1030, the data frame manager 1035, the A-MPDU manager 1040, and the capability manager 1045 may be implemented at least in part by a processor and software in the form of processor-executable code stored in memory.

The wireless communication device 1000 may support wireless communications in accordance with examples as disclosed herein. The configuration manager 1025 is configurable or configured to transmit a message indicating a format of an MPDU frame, from a set of multiple formats of the MPDU frame, or an interpretation configuration for one or more first fields of the MPDU frame, from a set of multiple interpretation configurations for the one or more first fields, or both. The MPDU frame manager 1030 is configurable or configured to transmit the MPDU frame in accordance with the format of the MPDU frame or the interpretation configuration for the one or more first fields, or both.

In some examples, the message be carried in one or more second fields of an MPDU delimiter corresponding to the MPDU frame. In some examples, the one or more second fields indicate the format of the MPDU frame or the interpretation configuration for the one or more first fields, or both.

In some examples, the MPDU delimiter include one or more reserved fields that indicate the format of the MPDU frame or the interpretation configuration for the one or more first fields, or both.

In some examples, the MPDU delimiter include a delimiter signature field. In some examples, a value of the delimiter signature field indicate the format of the MPDU frame or the interpretation configuration for the one or more first fields, or both.

In some examples, the message be a physical layer protocol data unit (PPDU). In some examples, one or more second fields in a preamble of the PPDU, one or more service fields of the PPDU, or both, indicate the format of the MPDU frame or the interpretation configuration for the one or more first fields, or both.

In some examples, the message be a MAC header. In some examples, one or more second fields in the MAC header indicate the format of the MPDU frame or the interpretation configuration for the one or more first fields, or both.

In some examples, the message include a bitmap. In some examples, a first bit of the bitmap indicate whether the MPDU frame includes one or more security fields. In some examples, a second bit of the bitmap indicate whether one or more second fields of the MPDU frame are expanded.

In some examples, the format of the MPDU frame or the interpretation configuration for the one or more first fields, or both, indicate at least one of a protection of a MAC header, that one or more second fields of the MPDU frame are expanded, or that one or more third fields of the MPDU frame carry timestamp information, or a combination thereof.

In some examples, the format of the MPDU frame or the interpretation configuration for the one or more first fields, or both, indicate at least one of a size of a high throughput control field exceeding a threshold, a presence of one or more security fields in the MPDU frame associated with the protection of the MAC header, a sequence number space being expanded based on a FN field, the sequence number space being expanded based on a PN field, or an interpretation for one or more third fields in the MAC header, from a set of multiple interpretations for the one or more third fields in the MAC header, or a combination thereof.

In some examples, to support receiving the message, the data frame manager 1035 is configurable or configured to receive a data frame associated with the MPDU frame, where the data frame includes one or more elements indicating the format of the MPDU frame or the interpretation configuration for the one or more first fields, or both.

In some examples, the configuration manager 1025 is configurable or configured to receive a second message indicating a second format of a second MPDU frame or a second interpretation configuration for one or more third fields of the second MPDU frame, or both. In some examples, the A-MPDU manager 1040 is configurable or configured to receive an aggregate MPDU including the MPDU frame and at least the second MPDU frame.

In some examples, the capability manager 1045 is configurable or configured to transmit a second message indicating a first capability of the first wireless device to support one or more formats of the MPDU frame, including at least the format, from the set of multiple formats of the MPDU frame, a second capability to support one or more interpretation configurations for the one or more first fields, including at least the interpretation configuration, from the set of multiple interpretation configurations for the one or more first fields, or both.

FIG. 11 shows a flowchart illustrating an example process 1100 performable by or at a first wireless device that supports indication of MPDU encoding. The operations of the process 1100 may be implemented by a first wireless device or its components as described herein. For example, the process 1100 may be performed by a wireless communication device, for example, the wireless communication device 900 described with reference to FIG. 9, operating as or within a wireless STA. In some examples, the process 1100 may be performed by a wireless STA, for example, one of the STAs 104 described with reference to FIG. 1.

In some examples, in block 1105, the first wireless device may receive a message indicating a format of an MPDU frame, from a set of multiple formats of the MPDU frame, or an interpretation configuration for one or more first fields of the MPDU frame, from a set of multiple interpretation configurations for the one or more first fields, or both. The operations of block 1105 may be performed in accordance with examples as disclosed herein. In some implementations, aspects of the operations of block 1105 may be performed by a configuration component 925 as described with reference to FIG. 9.

In some examples, in block 1110, the first wireless device may receive the MPDU frame. The operations of block 1110 may be performed in accordance with examples as disclosed herein. In some implementations, aspects of the operations of block 1110 may be performed by an MPDU frame component 930 as described with reference to FIG. 9.

In some examples, in block 1115, the first wireless device may decode the MPDU frame in accordance with the format of the MPDU frame or the interpretation configuration for the one or more first fields, or both. The operations of block 1115 may be performed in accordance with examples as disclosed herein. In some implementations, aspects of the operations of block 1115 may be performed by a decoding component 935 as described with reference to FIG. 9.

FIG. 12 shows a flowchart illustrating an example process 1200 performable by or at a first wireless device that supports indication of MPDU encoding. The operations of the process 1200 may be implemented by a first wireless device or its components as described herein. For example, the process 1200 may be performed by a wireless communication device, for example, the wireless communication device 900 described with reference to FIG. 9, operating as or within a wireless STA. In some examples, the process 1200 may be performed by a wireless STA, for example, one of the STAs 104 described with reference to FIG. 1.

In some examples, in block 1205, the first wireless device may transmit a second message indicating a first capability of the first wireless device to support one or more formats of an MPDU frame, including at least a format, from a set of multiple formats of the MPDU, a second capability to support one or more interpretation configurations for one or more first fields of the MPDU frame, including at least an interpretation configuration, from a set of multiple interpretation configurations for the one or more first fields, or both. The operations of block 1205 may be performed in accordance with examples as disclosed herein. In some implementations, aspects of the operations of block 1205 may be performed by a capability component 950 as described with reference to FIG. 9.

In some examples, in block 1210, the first wireless device may receive a message indicating the format of the MPDU frame, from the set of multiple formats of the MPDU frame, or the interpretation configuration for the one or more first fields of the MPDU frame, from the set of multiple interpretation configurations for the one or more first fields, or both. The operations of block 1210 may be performed in accordance with examples as disclosed herein. In some implementations, aspects of the operations of block 1210 may be performed by a configuration component 925 as described with reference to FIG. 9.

In some examples, in block 1215, the first wireless device may receive the MPDU frame. The operations of block 1215 may be performed in accordance with examples as disclosed herein. In some implementations, aspects of the operations of block 1215 may be performed by an MPDU frame component 930 as described with reference to FIG. 9.

In some examples, in block 1220, the first wireless device may decode the MPDU frame in accordance with the format of the MPDU frame or the interpretation configuration for the one or more first fields, or both. The operations of block 1220 may be performed in accordance with examples as disclosed herein. In some implementations, aspects of the operations of block 1220 may be performed by a decoding component 935 as described with reference to FIG. 9.

FIG. 13 shows a flowchart illustrating an example process 1300 performable by or at a first wireless device that supports indication of MPDU encoding. The operations of the process 1300 may be implemented by a first wireless device or its components as described herein. For example, the process 1300 may be performed by a wireless communication device, for example, the wireless communication device 1000 described with reference to FIG. 10, operating as or within a wireless AP. In some examples, the process 1300 may be performed by a wireless AP, for example, one of the APs 102 described with reference to FIG. 1.

In some examples, in block 1305, the first wireless device may transmit a message indicating a format of an MPDU frame, from a set of multiple formats of the MPDU frame, or an interpretation configuration for one or more first fields of the MPDU frame, from a set of multiple interpretation configurations for the one or more first fields, or both. The operations of block 1305 may be performed in accordance with examples as disclosed herein. In some implementations, aspects of the operations of block 1305 may be performed by a configuration manager 1025 as described with reference to FIG. 10.

In some examples, in block 1310, the first wireless device may transmit the MPDU frame in accordance with the format of the MPDU frame or the interpretation configuration for the one or more first fields, or both. The operations of block 1310 may be performed in accordance with examples as disclosed herein. In some implementations, aspects of the operations of block 1310 may be performed by an MPDU frame manager 1030 as described with reference to FIG. 10.

Implementation examples are described in the following numbered clauses:

Aspect 1: A method for wireless communications by a first wireless device, comprising: receiving a message indicating a format of a MPDU frame, from a plurality of formats of the MPDU frame, or an interpretation configuration for one or more first fields of the MPDU frame, from a plurality of interpretation configurations for the one or more first fields, or both; receiving the MPDU frame; and decoding the MPDU frame in accordance with the format of the MPDU frame or the interpretation configuration for the one or more first fields, or both.

Aspect 2: The method of aspect 1, where the message is carried in one or more second fields of an MPDU delimiter corresponding to the MPDU frame, and the one or more second fields indicate the format of the MPDU frame or the interpretation configuration for the one or more first fields, or both.

Aspect 3: The method of aspect 2, where the MPDU delimiter includes one or more reserved fields that indicate the format of the MPDU frame or the interpretation configuration for the one or more first fields, or both.

Aspect 4: The method of any of aspects 2-3, where the MPDU delimiter includes a delimiter signature field, and a value of the delimiter signature field indicates the format of the MPDU frame or the interpretation configuration for the one or more first fields, or both.

Aspect 5: The method of aspect 1, where the message is a PPDU, and one or more second fields in a preamble of the PPDU, one or more service fields of the PPDU, or both, indicate the format of the MPDU frame or the interpretation configuration for the one or more first fields, or both.

Aspect 6: The method of aspect 1, where the message is a MAC header, and one or more second fields in the MAC header indicate the format of the MPDU frame or the interpretation configuration for the one or more first fields, or both.

Aspect 7: The method of any of aspects 1-6, where the message includes a bitmap, a first bit of the bitmap indicates whether the MPDU frame includes one or more security fields, and a second bit of the bitmap indicates whether one or more second fields of the MPDU frame are expanded.

Aspect 8: The method of any of aspects 1-7, where the format of the MPDU frame or the interpretation configuration for the one or more first fields, or both, indicate at least one of a protection of a MAC header, that one or more second fields of the MPDU frame are expanded, or that one or more third fields of the MPDU frame carry timestamp information, or a combination thereof.

Aspect 9: The method of aspect 8, where the format of the MPDU frame or the interpretation configuration for the one or more first fields, or both, indicate at least one of a size of a high throughput control field exceeding a threshold, a presence of one or more security fields in the MPDU frame associated with the protection of the MAC header, a sequence number space being expanded based at least in part on a Fragment Number field, the sequence number space being expanded based at least in part on a Packet Number field, or an interpretation for one or more third fields in the MAC header, from a plurality of interpretations for the one or more third fields in the MAC header, or a combination thereof.

Aspect 10: The method of aspect 1, where receiving the message includes: receiving a data frame associated with the MPDU frame, where the data frame includes one or more elements indicating the format of the MPDU frame or the interpretation configuration for the one or more first fields, or both.

Aspect 11: The method of any of aspects 1-10, further comprising: receiving a second message indicating a second format of a second MPDU frame or a second interpretation configuration for one or more third fields of the second MPDU frame, or both; and receiving an aggregate MPDU comprising the MPDU frame and at least the second MPDU frame.

Aspect 12: The method of any of aspects 1-11, further comprising: transmitting a second message indicating a first capability of the first wireless device to support one or more formats of the MPDU frame, including at least the format, from the plurality of formats of the MPDU frame, a second capability to support one or more interpretation configurations for the one or more first fields, including at least the interpretation configuration, from the plurality of interpretation configurations for the one or more first fields, or both.

Aspect 13: A method for wireless communications by a first wireless device, comprising: transmitting a message indicating a format of a MPDU frame, from a plurality of formats of the MPDU frame, or an interpretation configuration for one or more first fields of the MPDU frame, from a plurality of interpretation configurations for the one or more first fields, or both; and transmitting the MPDU frame in accordance with the format of the MPDU frame or the interpretation configuration for the one or more first fields, or both.

Aspect 14: The method of aspect 13, where the message is carried in one or more second fields of an MPDU delimiter corresponding to the MPDU frame, and the one or more second fields indicate the format of the MPDU frame or the interpretation configuration for the one or more first fields, or both.

Aspect 15: The method of aspect 14, where the MPDU delimiter includes one or more reserved fields that indicate the format of the MPDU frame or the interpretation configuration for the one or more first fields, or both.

Aspect 16: The method of any of aspects 14-15, where the MPDU delimiter includes a delimiter signature field, and a value of the delimiter signature field indicates the format of the MPDU frame or the interpretation configuration for the one or more first fields, or both.

Aspect 17: The method of aspect 13, where the message is a PPDU, and one or more second fields in a preamble of the PPDU, one or more service fields of the PPDU, or both, indicate the format of the MPDU frame or the interpretation configuration for the one or more first fields, or both.

Aspect 18: The method of aspect 13, where the message is a MAC header, and one or more second fields in the MAC header indicate the format of the MPDU frame or the interpretation configuration for the one or more first fields, or both.

Aspect 19: The method of any of aspects 13-18, where the message includes a bitmap, a first bit of the bitmap indicates whether the MPDU frame includes one or more security fields, and a second bit of the bitmap indicates whether one or more second fields of the MPDU frame are expanded.

Aspect 20: The method of any of aspects 13-19, where the format of the MPDU frame or the interpretation configuration for the one or more first fields, or both, indicate at least one of a protection of a MAC header, that one or more second fields of the MPDU frame are expanded, or that one or more third fields of the MPDU frame carry timestamp information, or a combination thereof.

Aspect 21: The method of aspect 20, where the format of the MPDU frame or the interpretation configuration for the one or more first fields, or both, indicate at least one of a size of a high throughput control field exceeding a threshold, a presence of one or more security fields in the MPDU frame associated with the protection of the MAC header, a sequence number space being expanded based at least in part on a Fragment Number field, the sequence number space being expanded based at least in part on a Packet Number field, or an interpretation for one or more third fields in the MAC header, from a plurality of interpretations for the one or more third fields in the MAC header, or a combination thereof.

Aspect 22: The method of aspect 13, where receiving the message includes: receiving a data frame associated with the MPDU frame, where the data frame includes one or more elements indicating the format of the MPDU frame or the interpretation configuration for the one or more first fields, or both.

Aspect 23: The method of any of aspects 13-22, further comprising: receiving a second message indicating a second format of a second MPDU frame or a second interpretation configuration for one or more third fields of the second MPDU frame, or both; and receiving an aggregate MPDU comprising the MPDU frame and at least the second MPDU frame.

Aspect 24: The method of any of aspects 13-23, further comprising: transmitting a second message indicating a first capability of the first wireless device to support one or more formats of the MPDU frame, including at least the format, from the plurality of formats of the MPDU frame, a second capability to support one or more interpretation configurations for the one or more first fields, including at least the interpretation configuration, from the plurality of interpretation configurations for the one or more first fields, or both.

Aspect 25: A first wireless device for wireless communications, comprising one or more memories storing processor-executable code, and one or more processors coupled with the one or more memories and individually or collectively operable to execute the code to cause the first wireless device to perform a method of any of aspects 1-12.

Aspect 26: A first wireless device for wireless communications, comprising at least one means for performing a method of any of aspects 1-12.

Aspect 27: A non-transitory computer-readable medium storing code for wireless communications, the code comprising instructions executable by one or more processors to perform a method of any of aspects 1-12.

Aspect 28: A first wireless device for wireless communications, comprising one or more memories storing processor-executable code, and one or more processors coupled with the one or more memories and individually or collectively operable to execute the code to cause the first wireless device to perform a method of any of aspects 13-24.

Aspect 29: A first wireless device for wireless communications, comprising at least one means for performing a method of any of aspects 13-24.

Aspect 30: A non-transitory computer-readable medium storing code for wireless communications, the code comprising instructions executable by one or more processors to perform a method of any of aspects 13-24.

As used herein, the term “determine” or “determining” encompasses a wide variety of actions and, therefore, “determining” can include calculating, computing, processing, deriving, estimating, investigating, looking up (for example, via looking up in a table, a database, or another data structure), inferring, ascertaining, or measuring, among other possibilities. Also, “determining” can include receiving (for example, receiving information), accessing (for example, accessing data stored in memory) or transmitting (for example, transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive a message indicating a format of a medium access control (MAC) protocol data unit (MPDU) frame, from a plurality of formats of the MPDU frame, or an interpretation configuration for one or more first fields of the MPDU frame, from a plurality of interpretation configurations for the one or more first fields, or both;
receive the MPDU frame; and
decode the MPDU frame in accordance with the format of the MPDU frame or the interpretation configuration for the one or more first fields, or both.

2. The first wireless device of claim 1, wherein:
the message is carried in one or more second fields of an MPDU delimiter corresponding to the MPDU frame, and
the one or more second fields indicate the format of the MPDU frame or the interpretation configuration for the one or more first fields, or both.

3. The first wireless device of claim 2, wherein the MPDU delimiter comprises one or more reserved fields that indicate the format of the MPDU frame or the interpretation configuration for the one or more first fields, or both.

4. The first wireless device of claim 2, wherein:
the MPDU delimiter comprises a delimiter signature field, and
a value of the delimiter signature field indicates the format of the MPDU frame or the interpretation configuration for the one or more first fields, or both.

5. The first wireless device of claim 1, wherein:
the message is a physical layer protocol data unit (PPDU), and
one or more second fields in a preamble of the PPDU, one or more service fields of the PPDU, or both, indicate the format of the MPDU frame or the interpretation configuration for the one or more first fields, or both.

6. The first wireless device of claim 1, wherein:
the message is a MAC header, and
one or more second fields in the MAC header indicate the format of the MPDU frame or the interpretation configuration for the one or more first fields, or both.

7. The first wireless device of claim 1, wherein:
the message comprises a bitmap,
a first bit of the bitmap indicates whether the MPDU frame comprises one or more security fields, and
a second bit of the bitmap indicates whether one or more second fields of the MPDU frame are expanded.

8. The first wireless device of claim 1, wherein the format of the MPDU frame or the interpretation configuration for the one or more first fields, or both, indicate at least one of a protection of a MAC header, that one or more second fields of the MPDU frame are expanded, or that one or more third fields of the MPDU frame carry timestamp information, or a combination thereof.

9. The first wireless device of claim 8, wherein the format of the MPDU frame or the interpretation configuration for the one or more first fields, or both, indicate at least one of a size of a high throughput control field exceeding a threshold, a presence of one or more security fields in the MPDU frame associated with the protection of the MAC header, a sequence number space being expanded based at least in part on a Fragment Number field, the sequence number space being expanded based at least in part on a Packet Number field, or an interpretation for one or more third fields in the MAC header, from a plurality of interpretations for the one or more third fields in the MAC header, or a combination thereof.

10. The first wireless device of claim 1, wherein, to receive the message, the processing system is configured to cause the first wireless device to:
receive a data frame associated with the MPDU frame,
wherein the data frame comprises one or more elements indicating the format of the MPDU frame or the interpretation configuration for the one or more first fields, or both.

11. The first wireless device of claim 1, wherein the processing system is further configured to cause the first wireless device to:
receive a second message indicating a second format of a second MPDU frame or a second interpretation configuration for one or more third fields of the second MPDU frame, or both; and
receive an aggregate MPDU comprising the MPDU frame and at least the second MPDU frame.

12. The first wireless device of claim 1, wherein the processing system is further configured to cause the first wireless device to:
transmit a second message indicating a first capability of the first wireless device to support one or more formats of the MPDU frame, including at least the format, from the plurality of formats of the MPDU frame, a second capability to support one or more interpretation configurations for the one or more first fields, including at least the interpretation configuration, from the plurality of interpretation configurations for the one or more first fields, or both.

13. A first wireless device, comprising:
a processing system that includes processor circuitry and memory circuitry that stores code, the processing system configured to cause the first wireless device to:
transmit a message indicating a format of a medium access control (MAC) protocol data unit (MPDU) frame, from a plurality of formats of the MPDU frame, or an interpretation configuration for one or more first fields of the MPDU frame, from a plurality of interpretation configurations for the one or more first fields, or both; and
transmit the MPDU frame in accordance with the format of the MPDU frame or the interpretation configuration for the one or more first fields, or both.

14. The first wireless device of claim 13, wherein:
the message is carried in one or more second fields of an MPDU delimiter corresponding to the MPDU frame, and
the one or more second fields indicate the format of the MPDU frame or the interpretation configuration for the one or more first fields, or both.

15. The first wireless device of claim 14, wherein the MPDU delimiter comprises one or more reserved fields that indicate the format of the MPDU frame or the interpretation configuration for the one or more first fields, or both.

16. The first wireless device of claim 14, wherein:
the MPDU delimiter comprises a delimiter signature field, and
a value of the delimiter signature field indicates the format of the MPDU frame or the interpretation configuration for the one or more first fields, or both.

17. The first wireless device of claim 13, wherein:
the message is a physical layer protocol data unit (PPDU), and
one or more second fields in a preamble of the PPDU, one or more service fields of the PPDU, or both, indicate the format of the MPDU frame or the interpretation configuration for the one or more first fields, or both.

18. A method for wireless communications by a first wireless device, comprising:
receiving a message indicating a format of a medium access control (MAC) protocol data unit (MPDU) frame, from a plurality of formats of the MPDU frame, or an interpretation configuration for one or more first fields of the MPDU frame, from a plurality of interpretation configurations for the one or more first fields, or both;
receiving the MPDU frame; and
decoding the MPDU frame in accordance with the format of the MPDU frame or the interpretation configuration for the one or more first fields, or both.

19. The method of claim 18, wherein:
the message is carried in one or more second fields of an MPDU delimiter corresponding to the MPDU frame, and
the one or more second fields indicate the format of the MPDU frame or the interpretation configuration for the one or more first fields, or both.

20. The method of claim 18, wherein:
the message is a physical layer protocol data unit (PPDU), and
one or more second fields in a preamble of the PPDU, one or more service fields of the PPDU, or both, indicate the format of the MPDU frame or the interpretation configuration for the one or more first fields, or both.
